(19) United States
(12) Patent Application Publication
(10) Pub. No.: US 2026/0237235 A1
(43) Pub. Date: Aug. 13, 2026

(54) DOCUMENT PARSER USING VISUAL LARGE LANGUAGE MODELS AND ELECTRONIC FORMS

(71) Applicant: Anthony P. Macciola, Lake Forest, CA (US)

(72) Inventor: Anthony P. Macciola, Lake Forest, CA (US)

(21) Appl. No.: 19/408,243

(22) Filed: Dec. 3, 2025

Related U.S. Application Data
(60) Provisional application No. 63/702,828, filed on Oct. 3, 2024.

(51) Int. Cl. G06V 30/414; G06V 10/82

(52) U.S. Cl. CPC G06V 30/414; G06V 10/82

(57) ABSTRACT

A document parser and method for intelligent document processing utilizing Visual Large Language Models (VLLMs) and electronic forms (eForms). Sample documents are analyzed using VLLMs to automatically generate structural representations containing field labels, values, and geometric information. The structural representations are visualized for user review and curation. A multi-modal transformer-based machine learning model is trained using the curated structural representations. The trained model processes production documents and generates standardized output such as eForms or Electronic Data Interchange (EDI) formatted transactions. Synthetic documents may be auto-generated for training. The approach reduces manual labeling effort, provides faster training and deployment, and simplifies integration through standardized outputs.

### CROSS-REFERENCE TO RELATED APPLICATIONS

This application claims priority to U.S. Provisional Patent Application No. 63/702,828, filed Oct. 3, 2024, titled “Document Parser And Methods For Such,” which is incorporated herein by reference in its entirety.

### FIELD OF THE INVENTION

The present invention relates generally to intelligent document processing systems and methods. More particularly, the invention relates to document parsers that utilize Visual Large Language Models (VLLMs) and electronic forms (eForms) to automatically generate structural representations of documents for training artificial intelligence models used in document parsing and information extraction.

### BACKGROUND OF THE INVENTION

Conventional intelligent document processing solutions require substantial manual configuration and training to extract relevant information from documents. The typical workflow involves multiple labor-intensive steps:
1. Manual Training Data Preparation: Gathering representative sample documents that reflect the types of documents expected in production environments.
2. Manual Labeling: Manually identifying field labels and their associated values within training documents, which requires significant human effort and expertise.
3. Model Development: Building machine learning models based on manually labeled data.
4. Testing and Iteration: Running models against test documents, measuring accuracy and tolerance of field parsing results, and repeating the training process until desired fidelity is achieved.
5. Deployment: Publishing the trained model for production use.

Once trained and deployed, conventional intelligent document processing solutions typically generate multiple separate data streams (including image data and extracted field data) that must be transmitted back to host systems. This architecture requires significant integration effort to synchronize the multiple data streams and ensure consistency between the visual representation of documents and the extracted data.

There exists a need in the art for improved intelligent document processing systems and methods that:
Reduce or eliminate manual labeling requirements
Automate the training of document parsing models
Simplify integration with host systems
Provide standardized output formats
Maintain high accuracy and fidelity in document parsing
Enable faster deployment of document processing solutions

### SUMMARY OF THE INVENTION

The present invention addresses the aforementioned needs by providing document parsers, document parsing methods, and computer program products that leverage Visual Large Language Models (VLLMs) in combination with electronic forms (eForms) to automate the generation of structural representations used for training artificial intelligence models in intelligent document processing systems.

In preferred embodiments, the invention utilizes VLLMs to automatically analyze sample documents and generate structural representations containing field labels, values, and geometric information. These structural representations are correlated with training samples and curated for errors and omissions. The curated data is then used to train multi-modal transformer-based machine learning models that provide superior runtime performance compared to the VLLMs used during the design phase.

Certain embodiments utilize eForms (such as PDF eForms) as both inputs and outputs in the document processing workflow. eForm is used as a method for delivering synthetically generated training document samples, test document samples, and anonymized demo documents. eForms serve as sources of structural information (labels, values, geometry, validation rules) that can be parsed and used to train document parsing models, eliminating or reducing the need for manual labeling.

The trained models can generate eForms as output, automatically filling form fields with information extracted from processed documents, thereby providing a standardized output mechanism that simplifies integration with downstream systems.

### Synthetic Document Generation

Preferred embodiments include the capability to auto-generate synthetic documents for training, testing, and demonstration purposes. This approach reduces personally identifiable information (PII) risks and enables the creation of anonymized demo documents.

### Standardized Information Delivery

Certain embodiments provide standardized output formats including:
PDF eForms: Auto-filled electronic forms that can be read by any application capable of processing eForms
EDI (Electronic Data Interchange) Formats: Standard EDI transactions (e.g., EDI 835, EDI 810) that enable interoperability with systems supporting EDI standards

### Technical Advantages

Embodiments of the invention provide numerous technical advantages including:
Automated labeling using AI, reducing manual effort
Faster training and deployment of document parsing models
Higher runtime performance and fidelity through multi-modal transformer models
Simplified integration via standardized output formats
Reduced PII exposure through synthetic document generation
Automatic document classification enabling seamless processing without pre-specifying document types

### Primary Embodiment—Method

In one aspect, the invention provides a method of document parsing for use in intelligent document processing, comprising:
Loading a set of sample documents
Analyzing each sample document using one or more Visual Large Language Models to generate structural representations containing field labels, values, and geometry information
Presenting the structural representations to a user for review and confirmation
Generating document-level and field-level confidence levels
Iteratively refining the structural representations
Training a multi-modal transformer-based machine learning model using the refined structural representations
Using the trained model to process documents and generate standardized output for intelligent document processing

### Additional Aspects

The invention further encompasses document parsers implemented as computer systems, computer program products embodied in non-transitory computer-readable media, and intelligent document processing systems incorporating the disclosed methods and apparatus.

### BRIEF DESCRIPTION OF THE DRAWINGS

FIG. 1 is a flowchart illustrating a conventional manual labeling and machine learning process for document processing.

FIG. 2 is a flowchart illustrating an automated machine learning process according to an embodiment of the present invention.

FIG. 3 is a schematic diagram illustrating model training using eForms according to an embodiment of the invention.

FIG. 4 is a schematic diagram illustrating standard information delivery using PDF eForms as output according to an embodiment of the invention.

FIG. 5 is a schematic diagram illustrating standard information delivery using EDI format as output according to an embodiment of the invention.

FIG. 6 is a schematic diagram illustrating a machine learning training process using a training dataset according to an embodiment of the invention.

### DETAILED DESCRIPTION OF PREFERRED EMBODIMENTS

### Definitions

For clarity, the following terms as used throughout this specification have the meanings set forth below:

eForm refers to an electronic version of a form that can replace paper forms. An eForm captures, validates, and submits data to a recipient for electronic processing and transmission. eForms may be implemented in various formats including, but not limited to, PDF documents with fillable fields, HTML forms, XML-based forms, or other structured electronic document formats.

Electronic Data Interchange (EDI) refers to standardized formats for exchanging electronic documents between parties such as businesses, trading partners, and individuals. Common EDI standards include EDIFACT, Tradacoms, ANSI X12, EANCOM, and XML-based standards.

JSON (JavaScript Object Notation) refers to a standard text-based format for representing structured data based on JavaScript object syntax. JSON is commonly used for transmitting data in web applications.

Visual Large Language Model (VLLM) or Visual Language Model refers to artificial intelligence models capable of processing and understanding both visual information (images) and textual information. These models can analyze document images to identify structure, labels, values, and relationships within documents.

Multi-modal transformer model refers to machine learning models based on transformer architecture that can process multiple types of input data (e.g., text, images, geometry) and are trained for specific document parsing tasks.

MLOps (Machine Learning Operations) refers to practices that automate and simplify machine learning workflows and deployments, including data ingestion, model training, model deployment, model monitoring, and model retraining. MLOps sets of practices can include data ingest, exploratory data analysis, data prep and feature engineering, model training, model tuning, model deployment, model monitoring, model retraining, explainability, and others. MLOps as used herein may add efficiency such as faster model development, higher quality models, and faster deployment and production. MLOps may also enable scalability and management of multiple models and enable transparency and faster response to requests

Geometry or geometric information refers to spatial information about fields and elements within a document, including coordinates, bounding boxes, dimensions, and positional relationships.

Confidence level refers to a quantitative measure of the reliability or certainty of a prediction made by a machine learning model, typically expressed as a probability or percentage.

### SYSTEM ARCHITECTURE OVERVIEW

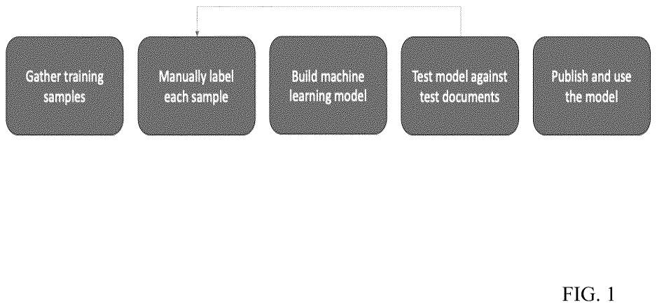

FIG. 1 shows an example of an overview of a typical document processing system that requires manual labeling of each sample document which is cumbersome and inefficient.

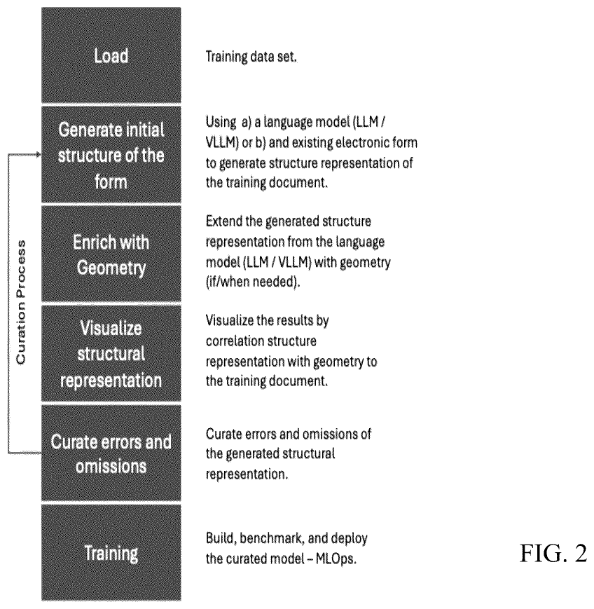

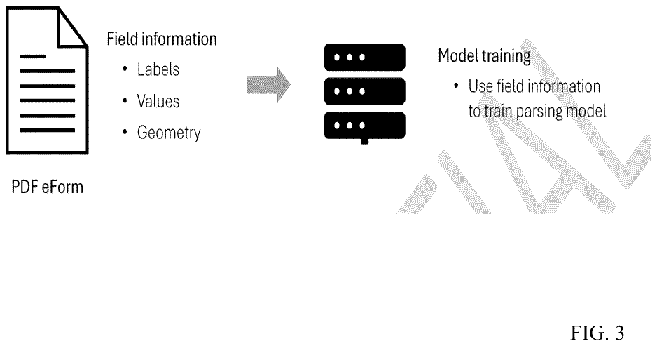

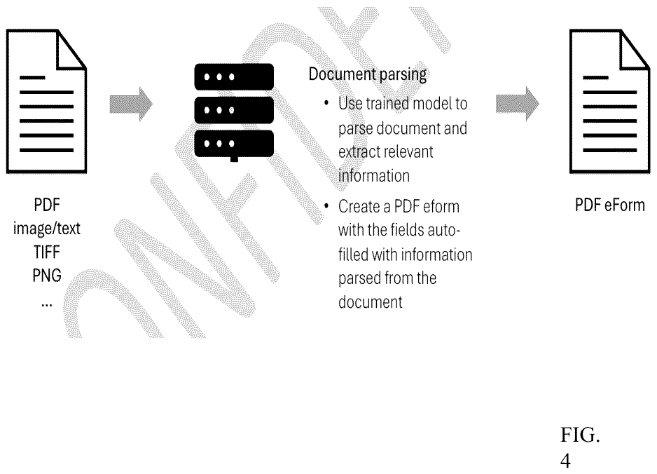

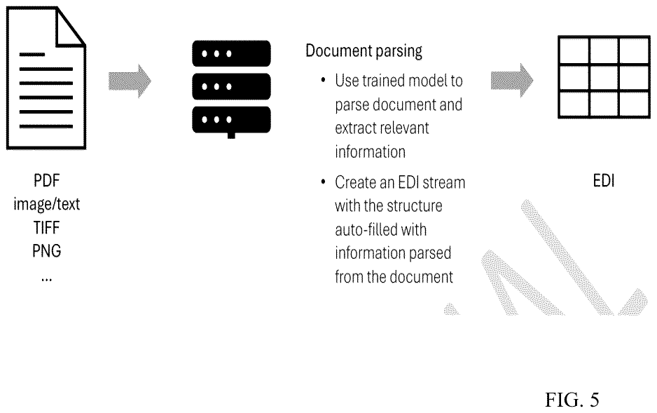

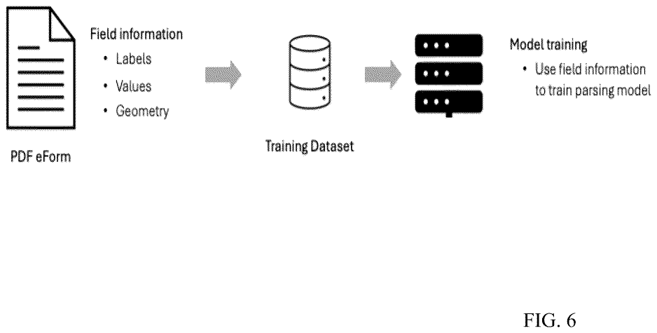

FIG. 2 shows an example of steps of certain embodiments of this invention wherein the process starts with the loading of a set of training data (e.g., documents), a structural representations of the input forms (e.g., JSON, eForms) is generated, the structural representations are extended and enriched with Visual Large Language models and geometry, certain results are visualized by correlating the structural representations and geometry with the training sample, errors and omissions in the generated structural representations are curated and certain steps are repeated, and the resulting models are trained. FIG. 3 shows an embodiment of this invention where a PDF eForm is used. Field information is collected (e.g., labels, values, geometry) and then a parsing model is trained using the field information. FIG. 4 shows an embodiment of this invention where a PDF, TIFF, or PNG formatted document is parsed using a trained model to extract relevant information. A PDF eForm is created with the fields auto-filled with information parsed from the document. The PDF eForm is used as the ouput result. FIG. 5 shows an embodiment of this invention where a PDF, TIFF, or PNG formatted document is parsed using a trained model to extract relevant information. An EDI stream with the structure auto-filled with information parsed from the document is used, creating an EDI conforming output. FIG. 6 shows an embodiment of this invention where a PDF eForm is used. Field information is collected (e.g., labels, values, geometry), a training dataset is created, and then a parsing model is trained using the field information.

A typical system includes:
A Document input module: For loading and preprocessing sample documents and production documents
A VLLM processing module: For analyzing documents using Visual Large Language Models
**Structural representation module**: For generating and managing structural representations of documents
Visualization module: For presenting structural representations to users for review
Curation module: For enabling user correction of errors and omissions
Model training module: For training multi-modal transformer models
Model deployment module: For deploying trained models via REST APIs or other interfaces
Output generation module: For generating standardized outputs (eForms, EDI, JSON)

### Core Methodology—Automated Document Parser Training

### Step 1: Project Creation and Document Loading

A user initiates the process by creating a project and loading a set of sample documents. Preferably, the sample set includes 20 or more documents representative of the document type to be processed, though the process can begin with as few as 5 sample documents depending on document complexity and variability. Sample documents may be in various formats including PDF, TIFF, PNG, JPEG, or other image formats.

### Step 2: Structural Analysis Using VLLMs

For each sample document, the system performs structural analysis. Two approaches are supported:

Approach A—eForm Input: If an electronic form representative of the document structure is available, the system parses the eForm to extract structural information including:
Field labels
Field values (if populated)
Geometric information (field locations and dimensions)
Validation rules
Field relationships and hierarchy.

This structural information serves as input for the training process, substantially reducing or eliminating manual labeling requirements.

Approach B—VLLM Analysis: If no eForm is available, the system analyzes each page of each sample document using one or more Visual Large Language Models to automatically generate structural representations. The system supports multiple VLLM options and allows users to select preferred models for analysis.

### Step 3: Multi-Pass Structural Relationship Generation

The system employs a multi-pass architecture that analyzes documents using multiple language models and multi-modal transformer models to identify and parse various structural elements including:
Key-value pairs
Optical Mark Recognition (OMR) zones (checkboxes, radio buttons)
Tables (with row and column structure)
Signature fields
Narrative text sections
Abstract or summary sections
Provisions and clauses.

For each identified structural element, the system automatically generates associated geometric information specifying the location, dimensions, and boundaries of the element within the document.

### Step 4: Visualization of Structural Representations

The system uses the geometric information generated in Step 3 to create visual representations that overlay the structural breakdown and relationships on the original document images. This visualization enables human operators to review the automated analysis and verify its accuracy.

### Step 5: Confidence Level Generation

The system automatically generates confidence levels at two granularities:
Document-level confidence: Overall confidence in the structural analysis of the entire document
Field-level confidence: Individual confidence scores for each identified field or structural element

These confidence levels assist users in identifying areas that may require closer review or correction.

### Step 6: Human Curation

A human operator reviews the visualized structural analysis using the interface provided by the system. The operator can:
Confirm correctly identified structures
Correct prediction errors
Adjust geometric assignments
Add missing fields or structures
Remove incorrectly identified elements.

The system provides learning analytics metrics to help determine overall model fidelity and accuracy, including precision, recall, and F1 scores at both document and field levels.

### Step 7: Iterative Processing

The user repeats Steps 2 through 6 for each sample document in the training set until all samples have been processed and curated.

### Step 8: Model Training and Deployment

Once the sample documents have been processed and curated, the user directs the system to build a multi-modal transformer-based machine learning model associated with the project. This training process actually creates two distinct models:

Parsing Model: A model trained to extract information from documents and return structured results (e.g., in JSON or eForm format) to host systems. This model leverages the curated structural representations to learn the specific layout, field types, and extraction rules for the target document type.

Classification Model: A model trained to identify document types at runtime. This model is automatically trained as a byproduct of creating the parsing model, enabling the system to automatically determine document type without requiring users to manually specify it when processing production documents.

The system provides standard MLOps capabilities including:
Model versioning and lineage tracking
Model performance benchmarking
Automated deployment to production environments
Model monitoring and drift detection
Automated retraining workflows.

### AI Training AI Approach

A key innovation of the present invention is the “AI training AI” approach, which references the strategy of using Visual Large Language Models at design time (which may be slower and less predictable) to bootstrap and simplify the labeling process, then using the output of this simplified labeling process to train faster, more accurate multi-modal transformer models for runtime use.

This two-stage approach provides several advantages:
1. Reduced Manual Effort: VLLMs automate the initial labeling that would otherwise require extensive manual work.
2. Higher Runtime Performance: The multi-modal transformer models trained using VLLM output provide substantially faster processing speeds than running VLLMs directly on production documents.
3. Improved Fidelity: The specialized transformer models achieve higher accuracy than general-purpose VLLMs for the specific document types they are trained on.
4. Geometric Information: Unlike VLLMs alone, the trained transformer models generate precise field geometry and confidence levels needed for runtime quality control and review. eForm-Based Training

In particularly preferred embodiments, PDF eForms or other electronic forms serve as inputs for training artificial intelligence models. The system parses the eForm structure to extract:
Field labels and names
Field types (text, checkbox, dropdown, etc.)
Field values (if populated)
Geometric information (field coordinates and dimensions)
Validation rules (format requirements, allowed values, etc.)
Field relationships and dependencies.

This structural information provides a rich training signal that enables rapid development of high-quality parsing models without manual labeling. The approach is particularly advantageous when:
Standard forms exist for the documents to be processed
Forms are consistently structured across samples
eForms with representative structures are available

### Standardized Information Delivery—Eform Output

Certain embodiments of the invention standardize information delivery by generating eForms as output. Once a parsing model is deployed, it can be configured to generate output in eForm format where:
1. The system processes an input document (which may be a scanned paper form, a PDF, or other document format).
2. The parsing model extracts field values from the input document.
3. The system creates an eForm (e.g., a PDF eForm) with the same structure as the original form.
4. The extracted field values are automatically filled into the corresponding fields of the output eForm.
5. The completed eForm is provided as the output result.

This approach provides significant advantages:
Standardization: The output format is consistent and well-defined.
Interoperability: Any application capable of reading eForms can process the output without custom integration.
Preservation of Structure: The original form structure and layout are maintained.
Validation: eForm validation rules can be applied to extracted data.

Importantly, the eForm output capability is independent of how the parsing model was trained. Models trained using VLLM analysis (without eForm input) can still generate eForm outputs if the target form structure is provided.

### Standardized Information Delivery—EDI Output

Alternative embodiments standardize information delivery using Electronic Data Interchange (EDI) formats. Once deployed, parsing models can be configured to generate EDI-compliant output transactions after parsing documents. Examples include:
Healthcare: Processing Explanation of Benefits (EOB) documents and generating EDI 835 Electronic Remittance Advice (ERA) transactions that can be consumed by healthcare billing systems.

Invoicing: Processing invoices and generating EDI 810 Invoice transactions that can be integrated into accounts payable systems.

This approach provides similar advantages to eForm output:
Industry Standards: EDI formats are widely adopted in many industries.
Seamless Integration: Systems supporting EDI can process the output without custom development.
Structured Data: EDI formats provide well-defined data structures.

### Synthetic Document Generation

Certain preferred embodiments include automated generation of synthetic documents for training, testing, and demonstration purposes. An administrator can specify the number of synthetic documents to create, and the system generates them using the following approaches:

Method 1—Simple Field Filling: The system fills form fields with synthetic data using the applicable eForm structure. Field types inform the type of synthetic data generated (e.g., names, dates, numbers).

Method 2—AI-Enhanced Generation: The system applies artificial intelligence to generate more realistic synthetic data that closely resembles actual production documents while maintaining anonymization. This may include:
Maintaining realistic value distributions
Preserving correlations between related fields
Generating contextually appropriate values
Ensuring data consistency across related fields

Synthetic documents provide multiple benefits:
PII Protection: Eliminates personally identifiable information risks associated with using real documents for training or demonstrations.
Training Augmentation: Expands training datasets to improve model robustness.
Testing: Provides controlled test cases with known expected outputs.
Marketing: Enables demonstration of capabilities without exposing real customer data.

### Runtime Document Processing

Once trained and deployed, the document parsing system processes production documents through the following workflow:
1. Document Submission: A document is submitted to the system via REST API or other interface.
2. Classification: The automatic classification model identifies the document type.
3. Model Selection: Based on the identified document type, the appropriate parsing model is automatically loaded.
4. Parsing: The parsing model extracts field values and generates confidence scores.
5. Output Generation: The system generates output in the configured format (JSON, eForm, EDI, etc.).
6. Quality Control: Fields with low confidence scores can be flagged for human review.
7. Result Delivery: The output is returned to the host system or application.

This automated workflow eliminates the need for users to manually specify document types or select parsing models, streamlining the integration of document processing into broader business processes.

### Computer System Implementation

The document parsers and methods of the present invention are implemented using computer systems comprising:

Processing Components: One or more processors or processing units capable of executing program instructions. These may include CPUs, GPUs (particularly for neural network operations), or specialized AI accelerators.

Memory: Random access memory (RAM) for storing program instructions and data during execution, including model parameters, document images, and intermediate processing results.

Storage: Non-volatile storage media (e.g., hard drives, solid-state drives, cloud storage) for persistently storing trained models, training datasets, configuration data, and processed documents.

Program Modules: Software modules implementing the various functions described herein, including:
Document ingestion and preprocessing modules
VLLM integration modules
Structural analysis modules
Visualization and user interface modules
Model training modules
Model deployment and serving modules
Output generation modules

Network Interfaces: Components enabling communication with external systems, including REST API interfaces, web service interfaces, and file transfer capabilities.

The system may be deployed in various configurations:
On-premises: Running on local servers within an organization's data center
Cloud-based: Running on cloud computing platforms (AWS, Azure, Google Cloud, etc.)
Hybrid: Combining on-premises and cloud components
Distributed: Distributed across multiple geographic locations or computing nodes

### Detailed Example Workflow

The following example illustrates a complete workflow for training and deploying a document parser for processing medical Explanation of Benefits (EOB) forms:

### Phase 1: Training Data Preparation

1. Create a project named “EOB_Parser_2024”
2. Load 25 sample EOB documents representing typical variations in format and content
3. If available, load a PDF eForm template representative of the EOB structure

### Phase 2: Automated Analysis

4. System analyzes the first EOB sample using a VLLM (e.g., GPT-4 Vision or similar)
5. VLLM identifies key fields: Patient Name, Date of Service, Provider, Procedure Codes, Charges, Adjustments, Patient Responsibility
6. System generates geometric bounding boxes for each identified field
7. System calculates confidence scores: Document (95%), Patient Name (98%), Charges (92%), etc.

### Phase 3: Human Review

8. User reviews visualized overlay showing identified fields on the document image
9. User corrects one mislabeled field (Adjustments field boundary was slightly off)
10. User adds one missing field (Secondary Insurance indicator)
11. System updates structural representation with corrections

### Phase 4: Iteration

12. Repeat steps 4-11 for remaining 24 sample documents
13. System tracks overall accuracy metrics across all samples
Phase 5: Model Training
14. User initiates model training
15. System trains two models:
   Parsing model for field extraction (trained on 25 curated samples)
   Classification model for EOB document identification
16. System benchmarks performance on held-out test documents: 97% field-level accuracy

### Phase 6: Deployment

17. User deploys models to production environment
18. System configures output format as EDI 835 transactions

### Phase 7: Production Use

19. Host system submits an EOB document to the API (without specifying document type)
20. Classification model identifies it as an EOB (confidence: 99%)
21. System loads the EOB parsing model
22. Parsing model extracts all fields with confidence scores
23. System generates EDI 835 transaction with extracted data
24. EDI 835 transaction is returned to host system for integration with billing system

This workflow demonstrates the end-to-end capabilities of the invention from training through production deployment.

### Alternative Embodiments and Variations

While the detailed description has focused on particularly preferred embodiments, the invention encompasses numerous variations:

VLLM Selection: Different Visual Large Language Models may be used including proprietary models (GPT-4 Vision, Claude with vision, Gemini Pro Vision) or open-source alternatives.

Form Formats: eForms may be implemented using various technologies including PDF forms, HTML forms, XForms, or proprietary form formats.

Output Formats: While eForms and EDI are emphasized, outputs may also include XML, JSON, CSV, or custom formats.

Document Types: While examples focus on forms, the methods apply to various document types including invoices, contracts, medical records, financial statements, legal documents, and more.

Training Dataset Sizes: While 20+ samples are preferred, acceptable models can be trained with as few as 5 samples depending on document complexity and variability.

Multi-modal Architectures: Various transformer architectures may be employed including LayoutLM, DocFormer, or custom architectures optimized for specific document types.

Human-in-the-Loop Variations: The level of human curation may vary from minimal (high-confidence cases) to extensive (complex documents with low initial accuracy).

1. A method of training a document parser for intelligent document processing, the method comprising:
(a) loading a plurality of sample documents into a computer system;
(b) analyzing each sample document using at least one Visual Large Language Model to generate a structural representation for each sample document, wherein each structural representation comprises field labels, field values, and geometric information specifying locations of fields within the sample document;
(c) presenting the structural representations to a user through a user interface for review and confirmation;
(d) generating document-level confidence scores and field-level confidence scores for the plurality of sample documents;
(e) receiving user input to curate the structural representations;
(f) training a multi-modal transformer-based machine learning model using the curated structural representations; and
(g) deploying the trained multi-modal transformer-based machine learning model to process production documents and generate output for use in intelligent document processing.

2. The method of claim 1, wherein the output generated by the trained model comprises an electronic form (eForm) with fields automatically populated with information extracted from processed production documents.

3. The method of claim 2, wherein the eForm comprises a PDF form with fillable fields.

4. The method of claim 1, wherein the output generated by the trained model comprises an Electronic Data Interchange (EDI) transaction conforming to an EDI standard.

5. The method of claim 4, wherein the EDI transaction comprises an EDI 835 Electronic Remittance Advice transaction or an EDI 810 Invoice transaction.

6. The method of claim 1, wherein at least some of the plurality of sample documents comprise synthetically generated documents created by automatically filling fields of a form template with synthetic data.

7. The method of claim 6, wherein the synthetic data is generated using artificial intelligence to produce realistic values that preserve anonymization.

8. The method of claim 1, wherein step (b) comprises:
parsing an electronic form (eForm) representative of a structure of the sample documents to extract field labels, field values, and geometric information; and
using the extracted information as the structural representation.

9. The method of claim 1, wherein step (b) comprises analyzing each sample document using a multi-pass architecture that applies multiple Visual Large Language Models to identify multiple types of structural elements including key-value pairs, tables, optical mark recognition zones, signature fields, and narrative text sections.

10. The method of claim 1, wherein step (f) further comprises automatically training a classification model configured to identify document types, wherein the classification model is trained concurrently with the multi-modal transformer-based machine learning model.

11. The method of claim 10, further comprising:
receiving a production document without document type information;
applying the classification model to identify a document type of the production document;
automatically selecting a parsing model corresponding to the identified document type; and
applying the selected parsing model to extract information from the production document.

12. A method of intelligent document processing comprising:
(a) loading training data comprising a plurality of sample documents;
(b) generating an initial form structure from the training data using at least one Visual Large Language Model;
(c) enriching the initial form structure with geometric information using the at least one Visual Large Language Model to create an enriched form structure;
(d) visualizing the enriched form structure by correlating structural representations with the sample documents;
(e) receiving user input to curate errors and omissions in the enriched form structure to create a curated form structure; and
(f) training a machine learning model using the curated form structure to generate a trained model configured to produce standardized output for intelligent document processing.

13. The method of claim 12, wherein the standardized output comprises electronic forms (eForms).

14. The method of claim 12, wherein the standardized output comprises Electronic Data Interchange (EDI) formatted transactions.

15. The method of claim 12, further comprising generating synthetic training documents by automatically populating fields of an electronic form template with synthetic data.

16. A document parser system comprising:
a processor;
a memory coupled to the processor;
an input interface configured to load a plurality of sample documents;
a Visual Large Language Model processing module executed by the processor and configured to analyze each sample document to generate structural representations comprising field labels, field values, and geometric information;
a visualization module configured to present the structural representations to a user for review;
a curation module configured to receive user corrections to the structural representations;
a model training module configured to train a multi-modal transformer-based machine learning model using curated structural representations; and
an output module configured to apply the trained model to production documents to generate standardized output for intelligent document processing.

17. The document parser system of claim 16, wherein the standardized output comprises electronic forms (eForms) with automatically populated fields.

18. The document parser system of claim 16, wherein the standardized output comprises Electronic Data Interchange (EDI) formatted transactions.

19. The document parser system of claim 16, further comprising a synthetic document generation module configured to automatically generate synthetic training documents by populating form templates with synthetic data.

20. The document parser system of claim 16, wherein the Visual Large Language Model processing module is configured to apply multiple Visual Large Language Models using a multi-pass architecture to identify different types of structural elements within documents.

21. The document parser system of claim 16, wherein the model training module is further configured to automatically train a classification model for identifying document types concurrently with training the multi-modal transformer-based machine learning model.

22. A non-transitory computer-readable storage medium containing instructions that, when executed by a processor, cause the processor to perform operations comprising:
loading a plurality of sample documents;
analyzing each sample document using at least one Visual Large Language Model to generate structural representations comprising field labels, field values, and geometric information;
presenting the structural representations for user review and receiving user corrections;
training a multi-modal transformer-based machine learning model using corrected structural representations; and
deploying the trained model to process production documents and generate standardized output selected from the group consisting of electronic forms (eForms) and Electronic Data Interchange (EDI) formatted transactions.

23. A method of intelligent document processing comprising:
training a plurality of Visual Large Language Models using a plurality of sample documents, wherein each sample document is provided in electronic form (eForm) format; and
deploying trained models derived from the trained Visual Large Language Models for processing production documents.

24. A method of intelligent document processing comprising:
processing input documents using trained document parsing models to extract information; and
generating output comprising electronic forms (eForms) that are automatically created and populated with the extracted information.

25. A method of intelligent document processing comprising:
processing input documents using trained document parsing models to extract information; and
generating output comprising Electronic Data Interchange (EDI) formatted transactions populated with the extracted information.

26. A method of intelligent document processing comprising training Visual Large Language Models using synthetically generated sample documents created by automatically populating form templates with synthetic data.

27. An intelligent document processing system comprising the document parser of claim 16 and configured to:
receive production documents from external systems;
automatically classify received documents by document type;
apply document-type-specific parsing models to extract information from the received documents; and
return standardized output to the external systems.

28. The system of claim 27, wherein the standardized output comprises electronic forms (eForms) or Electronic Data Interchange (EDI) formatted transactions.

29. The method of claim 1, wherein the geometric information comprises coordinate information defining bounding boxes for fields within the sample documents.

30. The method of claim 1, further comprising:
automatically generating confidence levels for each field identified in the structural representations; and
flagging fields having confidence levels below a predetermined threshold for user review.
